(19) United States
(12) Patent Application Publication
(10) Pub. No.: US 2012/0151659 A1
(43) Pub. Date: Jun. 21, 2012

(54) Material With Enhanced Features

(76) Inventors: Lisa Marie Sanabria, Alpharetta, GA (US); Martin Scott Shamis, Alpharetta, GA (US); Christopher Matthew Sinotte, Duluth, GA (US); Russell Frederick Ross, Atlanta, GA (US)

(21) Appl. No.: 12/972,656

(22) Filed: Dec. 20, 2010

(51) Int. Cl. A41D 19/015; B29C 59/02; A41D 19/00; B32B 3/30

(52) U.S. Cl. 2/167; 428/156; 264/293

(57) ABSTRACT

The present invention is generally directed to a grip enhancing material that includes a polymeric sheet having a first surface and a second surface, a plurality of elongated flexible bristles contiguous with the first surface, the elongated flexible bristles having a root proximate to the first surface, a tip spaced apart from the first surface, wherein at least a portion of the flexible bristles have an average aspect ratio of at least about 1:5, and wherein at least a portion of the flexible bristles have an average length of less than about 15 microns.

### BACKGROUND

There are many instances when it is necessary or desirable to pick up objects which are difficult to grasp due to their shape or surface characteristics with either a human hand or equipment. In circumstances when a person must pick up such objects, gloves can be worn to protect against possible injury such as, for example, when picking up and moving glass sheets or items which are wet with harmful substances such as oil.

Some materials which increase the ability to grip on an object wear out over time or become occluded with dirt or debris and lose their effectiveness, or leave residue on the object. Attractive forces between molecules have been shown to have successfully provided adhesion between two surfaces, where one of the surfaces has millions of tiny flexible projections. The angle of incidence between the tiny flexible projections and the other surface can be altered to separate the two surfaces. Such surfaces can be self-cleaning and leave no residue.

While some progress has been made to produce a material which provides an enhanced ability to grip objects without the aforementioned drawbacks, further improvements are needed to bring into being an easy to use and readily producible material which provides an enhanced grip.

### SUMMARY

In accordance with one embodiment of the present invention, a grip enhancing material is disclosed. The grip enhancing material may include a polymeric sheet having a first surface and a second surface, and a plurality of elongated flexible bristles contiguous with and extending upwardly from the first surface. The elongated flexible bristles each have a root proximate to the first surface and a tip spaced apart from the first surface. In selected embodiments, each bristle has a substantially continuous cross-sectional shape from the root to the tip of each bristle, and bristles may have cross-sectional shapes which differ from other bristles on the grip enhancing material.

The polymeric sheet may include one or more polymers, including polypropylene and polyethylene.

In some embodiments, at least a portion of the flexible bristles may have an average aspect ratio of at least about 1:5. Such embodiments may also have an average aspect ratio less than about 1:30. In particular embodiments, at least a portion of the flexible bristles may have an average length of less than about 15 microns.

For certain embodiments, the grip enhancing material may have at least about 10 million bristles per square centimeter, while some embodiments may have at least about 20 million bristles per square centimeter. In these and other embodiments, some of the bristles or groups of bristles may be spaced apart from each other by at least about one micron.

The grip enhancing material of the present invention may be applied to a number of items such as equipment useful in handling objects, gloves, or the objects themselves. When applied to a glove, the grip enhancing material may be located on the entire outer surface or a portion of the outer surface of the glove. Some embodiments may use the grip enhancing material on selective portions of the glove such as the fingertips or palm region.

The present invention further includes a method for forming a grip enhancing material that includes the steps of providing a porous material having a plurality of pores having an average width of less than about 2 microns which extend into the porous material for at least about 10 microns. A polymeric sheet is positioned adjacent to the porous material. A combination of pressure and temperature are applied to the porous material and polymeric sheet sufficient to cause at least a portion of the polymeric sheet to flow into at least a portion of the pores in the porous material. The porous material is then dissolved in a solvent so that the polymeric sheet is separated from the porous material. In some embodiments, the porous material and polymeric sheet are immersed in a solvent such as, for example, methyl chloride.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 is a photomicrograph of an embodiment of the material of the present invention.

FIG. 2 is a photomicrograph of an embodiment of the material of the present invention.

FIG. 3 is a photomicrograph of an embodiment of the material of the present invention.

FIG. 4 is a photomicrograph of one side of a porous material.

FIG. 5 is a photomicrograph of another side of the porous material shown in FIG. 4.

FIG. 6 is a photomicrograph of a cross-section of the porous material shown in FIGS. 4 and 5.

FIG. 7 is a perspective view of the material of the present invention.

FIG. 8 is a perspective view of a glove including the material of the present invention.

FIG. 9 is a perspective view of an alternate glove including the material of the present invention.

FIG. 10 is a photograph of the material of the present invention supporting various weights.

### DETAILED DESCRIPTION

Reference will now be made in detail to various embodiments of the disclosed subject matter, one or more examples of which are set forth below. Each embodiment is provided by way of explanation of the subject matter, not limitation of the subject matter. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment. Thus, it is intended that the present disclosure cover such modifications and variations as come within the scope of the appended claims and their equivalents.

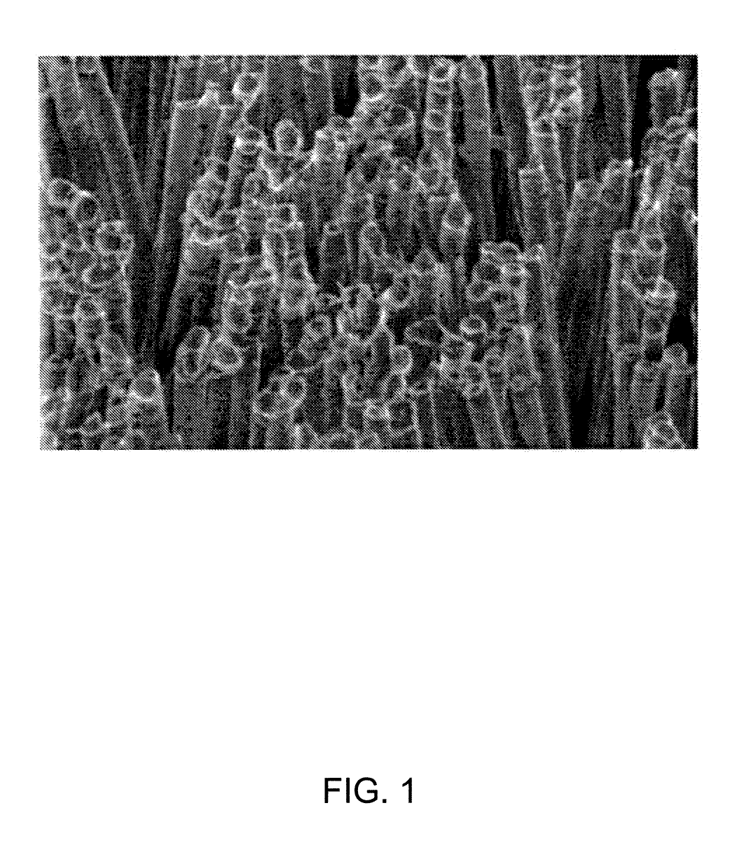

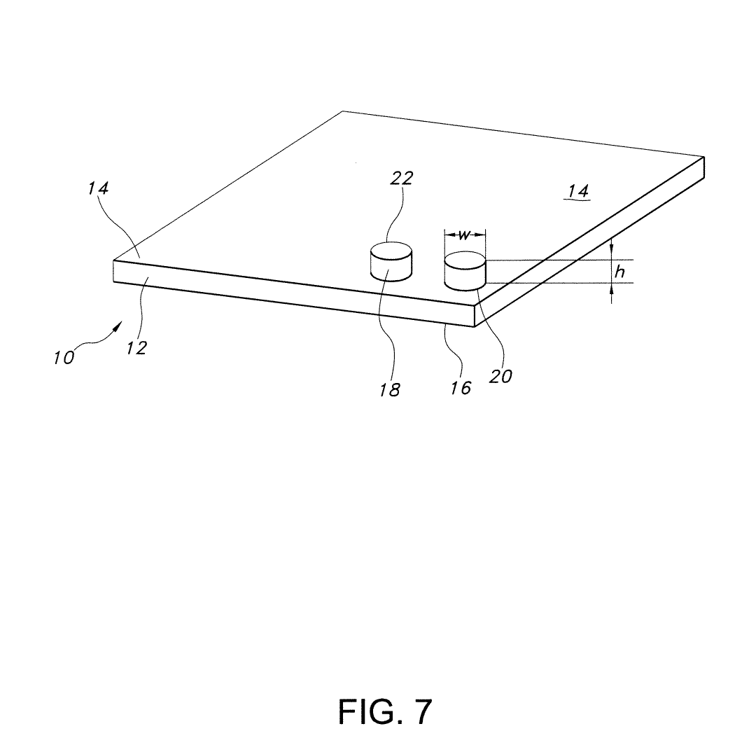

Generally speaking, the present invention is directed to a grip enhancing material that may be utilized in combination with a glove, equipment or object which can benefit from having an improved ability to grip or be gripped. As shown in the figures, and in particular FIG. 7, a polymeric sheet 12 has a first surface 14 and a second surface 16. A plurality of flexible elongated bristles 18 are positioned upon the first surface 14 and are contiguous with the first surface 14. That is, the bristles 18 extend upwardly from the first surface 14 without a break. These features of the present invention are visible in FIGS. 1-3. The bristles 18 may be formed from the material of the polymeric sheet 12.

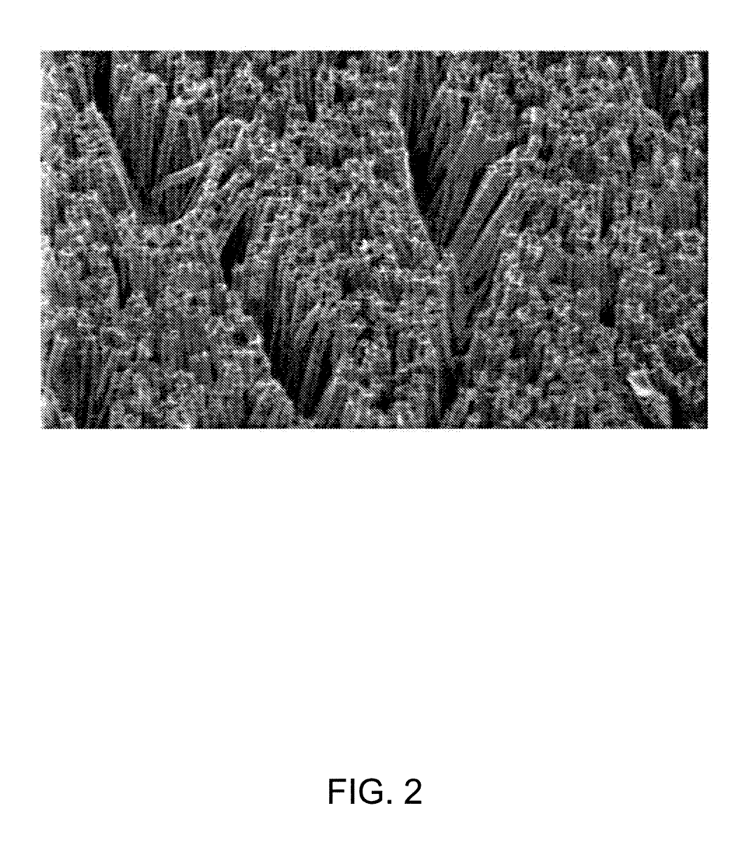

Each bristle 18 has a root 20 which is proximate to the first surface 14, and a tip 22 which is spaced apart from the root 20. The distance between the root 20 and tip 22 is the height of the bristle 18. The diameter of the bristle 18 is the largest width dimension of the bristle 18 at its root 20. FIGS. 1 and 2 are photomicrographs of embodiments of bristles which were produced in accordance with the process described below which creates bristles directly onto the finger of a glove. Measurements taken from the photomicrographs of the invention, including those shown in FIGS. 1 and 2, illustrate that the bristles may have a height which may range from about 9 to about 12 microns and a diameter or width which ranges from about 0.6 to about 1.4 microns.

The average aspect ratio of the bristles 18 may range widely, but should be at least about 1:5. The average width for bristles 18 within a section of grip enhancing material may be calculated by measuring, via a photomicrograph, the width of each of a group of bristles 18 at their roots. The average width may be found by adding the width of each bristle 18 at its root and dividing by the number of bristles measured. It is preferable that at least 20 bristles are measured. Similarly, the average height of the bristles 18 may also be calculated from a photomicrograph.

Each bristle 18 has a substantially continuous cross-sectional shape along its length. While the bristles shown in the photomicrographs have a substantially circular cross-sectional shape, other cross-sectional shapes such as elliptical or conical may be used. The cross-sectional shape of the bristles may also differ from each other.

The grip enhancing material of the present invention may be manufactured by a variety of methods. A preferred method for manufacturing the grip enhancing material is by providing a porous material that has a large number of small openings or pores. A polymeric sheet is positioned adjacent to the porous material. Pressure and temperature may be applied to the porous material and polymeric sheet to cause polymer to flow into at least a portion of the pores in the porous material. After cooling, a solvent is utilized to dissolve the porous material so that the polymeric sheet and the bristles formed by the pores are accessible.

A wide variety of polymers may be used to form polymeric sheets useful in the present invention. For example, useful polymers can include natural and synthetic polymers as well as copolymers and blends thereof. Synthetic polymers such as polyethylene and polypropylene are particularly useful in the present invention. The polymeric materials may also include any of a variety of known additives, such as dyes, stabilizers, plasticizers, ultraviolet light stabilizing agents, and so forth. In addition, additives can be included in the polymeric materials to be molded, e.g., in the melt, or can be applied as a surface treatment the molded polymeric material. Additionally, polymeric sheets useful in the present invention may also be stretchable and may retract or recover upon release of a stretching force.

While many different porous materials may be utilized in the present invention, microporous filter materials such as Isopore™ Membrane Filters are particularly suitable for use in the present invention and are available from Millipore (Billerica, Mass. U.S.A.). These membrane filters are formed from polycarbonate, are track-etched and provide a consistent pore size. One exemplary membrane filter which was used as a porous material had a thickness of between 7 and 22 microns and porosity of between about 5 and 20%. Pore size can vary between about 0.05 and about 12 microns, although suitable pore sizes for use in the present invention may range from about 0.22 to about 1.2 microns, and may range from about 0.4 to about 0.6 microns.

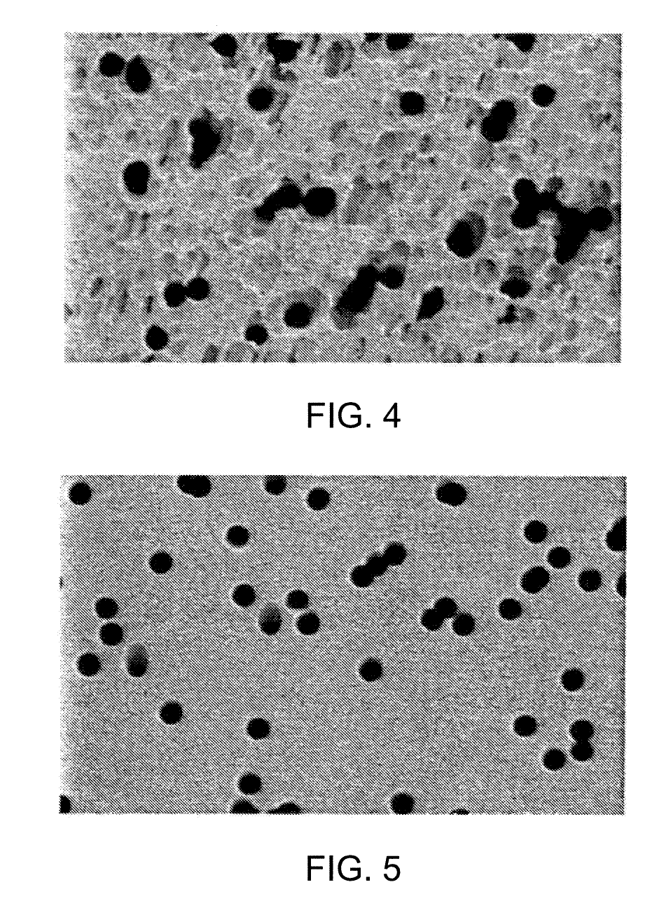

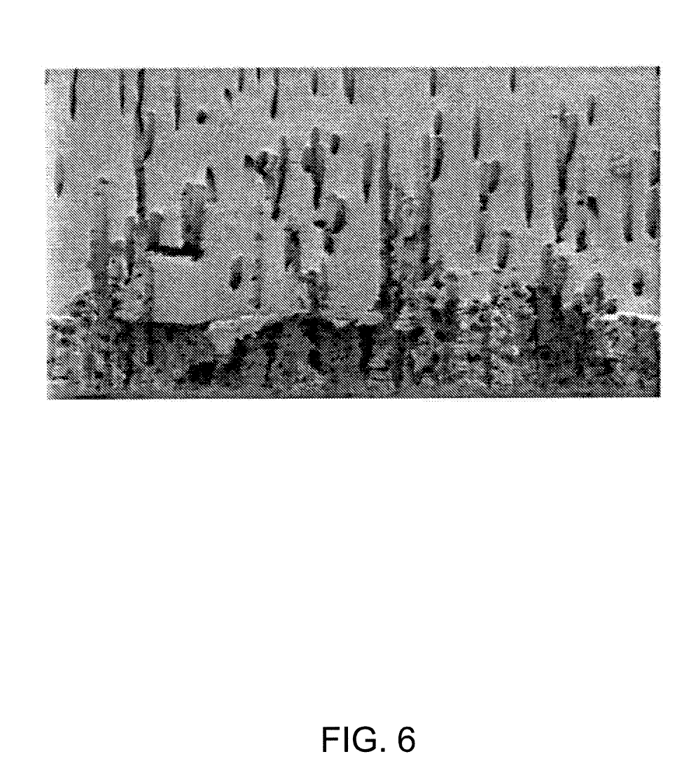

FIGS. 4 and 5 are photomicrographs of an Isopore™ filter membrane which was utilized as a porous material in numerous examples described below. FIG. 4 depicts the rough or matte side of the porous material while FIG. 5 depicts the smooth or shiny side of the porous material. The pores, as measured in FIG. 5, are about 0.6 microns in diameter.

Organic or inorganic solvents may be used in the process of the present invention. Particular solvents which may be of use include methylene chloride, acetonitrile, ethyl acetate, dimethyl sulfoxide, toluene, cyclopentane, acetone, ethanol, acetic acid and the like.

Samples of the present invention were produced using variations of the process described above. For example, the material produced and shown in FIGS. 1 and 2 was produced by placing a low density polyethylene (LDPE) film adjacent to a finger of a glove having an exterior layer of high density polyethylene (HDPE). An Isopore™ filter with pores having an average diameter of 0.22 microns was positioned adjacent to the LDPE film such that the LDPE film was disposed between the glove and the porous filter material. A glass slide was placed on the other side of the porous filter material. A section of Teflon™ coated aluminum sheet was positioned on the opposite side of the glove finger. Hence, the materials were stacked in the following order: glass slide, porous filter, LDPE film, HDPE glove finger, Teflon™ sheet. One stack was made on each glove finger. Each stack of materials was laminated and subjected to relatively low pressures and temperatures ranging from about 140° F. to about 155° F. The glass and Teflon™ sheet was removed from each stack of materials. Methylene chloride was used to dissolve the porous filter material.

As can be seen in FIGS. 1 and 2, the resulting bristles are generally uniform in cross-sectional shape and height. The bristles of the enhanced gripping material depicted in FIGS. 1 and 2 ranges in height from about 9 to about 12 microns, and have widths from about 0.6 to about 0.4 microns in diameter, as measured in the photomicrographs. While the aspect ratio of the bristles may vary from sample to sample, the aspect ratio may be greater than about 1:5 and less than about 1:30.

Additional samples were produced and are described in Tables 1, 2 and 3. Each sample was produced using a relatively standard set of steps. First, materials were stacked in an appropriate order. A smooth metal plate was positioned as the lowest external layer of the stack. A Teflon® coated aluminum sheet roughly the same size or slightly smaller than the metal plate was placed on top of the metal plate with the Teflon® coating facing upwards. The porous material was positioned on top of the aluminum sheet. The polymeric sheet was positioned on top of the porous material. If a porous material was utilized which did not have identical characteristics on both surfaces of the porous material, the side of the porous material that was to be positioned adjacent to the polymeric sheet would be positioned facing upwards. An additional Teflon® coated aluminum sheet was placed on top of the polymeric sheet with the Teflon® coating adjacent to the polymeric sheet. Another metal plate was placed on top of the aluminum sheet.

The stacked materials were positioned between the heated plates in a Carver Press and processed at the settings shown in the tables for each sample.

Process parameters were controlled to prevent overfilling or underfilling of the pores in the porous material. The stacked materials were held at the pressures and temperatures shown in the tables. At the appropriate time, the pressure was released and the samples were cooled. For some samples, the stacked materials were placed in the cooling plates of the press and pneumatically pressurized for three minutes. For other samples, the stacked materials were cooled at ambient pressure and temperature.

The polymeric sheet and the porous material were removed from the stack, with care being taken not to bend or wrinkle the materials. The materials were placed in methylene chloride for 10 minutes. The materials were then placed in fresh methylene chloride for an additional 5 minutes. The polymeric material was removed from the methylene chloride and rinsed in isopropanol for 5 minutes and allowed to air dry.

For the samples described in Table 1, the polymeric material used for each sample was a polypropylene thin film available from Premier Lab Supply (Port St. Lucie, Fla. U.S.A.) in roll form as catalog number TF-225 (also referred to herein as “xray PP film”). This general purpose x-ray transmission film was 25.4 micron (1.15 mil) thick. The porous material used in each sample in Table 1 was a polycarbonate track-etched Isopore™ Membrane Filter available from Millipore (Billerica, Mass. U.S.A). The membrane filter had a pore size of 0.6 microns and a thickness of 25 microns.

For selected samples, shims were placed between the plates of the press, preventing the press from closing to a distance smaller than the shims.

TABLE 1

| | Heating | Formation | | |
|---|---|---|---|---|
| | Time | Pressure | Formation | Shims |
| Code | (min) | (lbs) | Temp (F) | (in.) |
| 1 | 2 | 2500 | 360-420 | none |
| 2 | 3 | 2500 | 360-420 | none |
| 3 | 3 | 4000 | 360-420 | none |
| 4 | 3 | 7500 | 360-420 | none |
| 5 | 3 | 17500 | 360-420 | none |
| 6 | 3 | 17500 | 360-420 | none |
| 7 | 3 | 2500 | 410 | none |
| 8 | 2 | 2500 | 350 | none |
| 9* | 2 | 4900 | 350 | 0.171 |
| 10 | 2 | 4900 | 350 | none |
| 11 | 2 | 4900 | 350 | 0.202 |
| 12 | 2 | 8000 | 350 | none |
| 13 | 2 | 4900 | 360 | none |
| 14 | 2 | 4200-5300 | 360 | none |
| 15 | 2 | 4200-5300 | 370 | none |
| 16 | 2 | 4200-5300 | 380 | none |
| 17 | 2 | 4200-5300 | 390 | none |
| 18 | 2 | 4200-5300 | 400 | none |
| 19 | 2 | 4200-5300 | 410 | none |
| 20 | 2 | 4200-5300 | 420 | none |
| 21 | 2 | 2500 | 320-380 | none |
| 22 | 2 | 2500 | 320-380 | none |
| 23 | 3 | 2500 | 400 | none |
| 24 | 2 | 2500 | 400 | none |
| 25 | 2 | 2500 | 420 | none |
| 26 | 2 | 2500 | 420 | none |
| 27 | 2 | 2500 | 420 | none |
| 28 | 2 | 2500 | 420 | none |
| 29 | 2 | 4000 | 420 | 0.004 |
| 30 | 2 | 4000 | 420 | 0.079 |
| 31 | 2 | 4000 | 420 | 0.154 |
| 32 | 2 | 4000 | 420 | 0.154 |
| 33 | 2 | 4000 | 420 | 0.155 |
| 34 | 2 | 4000 | 420 | 0.153 |
| 37 | 2 | 4000 | 420 | 0.177 |
| 38 | 2 | 2700 | 420 | 0.177 |
| 39 | 2 | 4400 | 420 | 0.177 |
| 40 | 2 | 4400 | 420 | 0.095 |
| 41 | 2 | 4200 | 420 | 0.47 |
| 42 | 2 | Less than | 410 | No |
| | | 2500 | | |
| 43 | 2 | 2500 | 460 | none |

For each of the samples in Table 1. The amount of time which each sample was permitted to cool before handling varied from 1 to 3 minutes or longer.

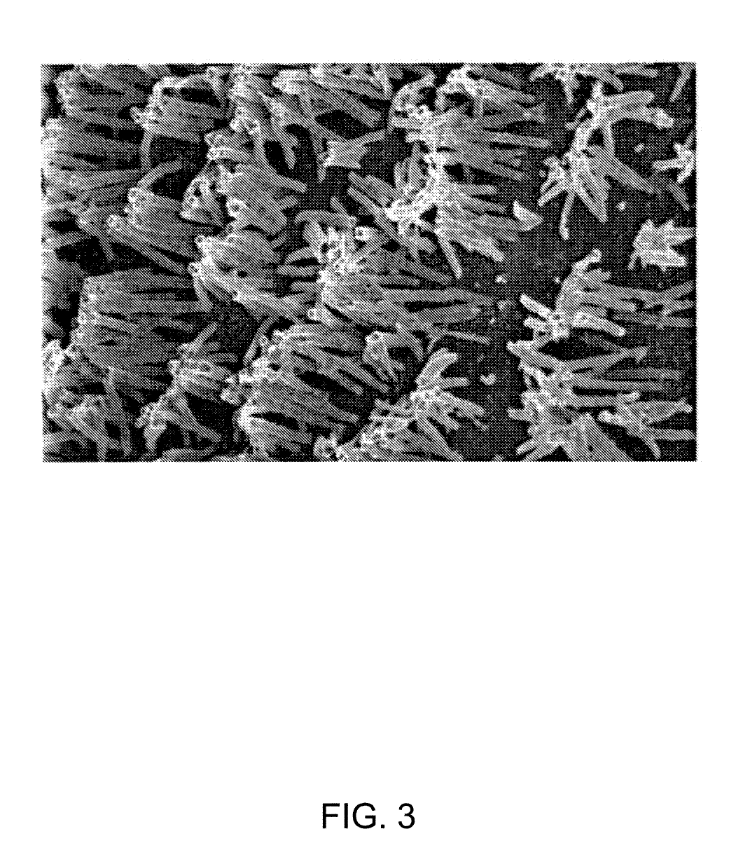

The samples of Table 1 generally showed good formation in that the bristles were consistently distributed throughout the sample at an appropriate density and maintained their attachment to the porous material, were standing upwardly from the surface of the porous material and were substantially uniform in shape. FIG. 3 is a photomicrograph of sample 1 from Table 1 and shows bristles which are roughly cylindrical extending upwardly from the surface of the polymeric material.

TABLE 2

| | | Heating | |
|---|---|---|---|
| | | Time | Formation |
| Sample | Polymer Substrate | (min) | Temp (F) |
| 1 | polyethylene film | 3 | 360-420 |
| 2 | Dow PP 2252E4 | 2 | 420 |
| 3 | Dow PP 3155 | 2 | 320 |
| 4 | Dow PP 3155 | 1 | 410 |
| 5 | Dow PP 3155 | 0.5 | 410 |
| 6 | Dow PP 3155 | 1 | 320-350 |
| 7 | Dow PP 3155 | 0.5 | 320-350 |
| 8 | Dow PP 3155 | 2 | 340-370 |
| 9 | Dow PP 3155 | 3 | 360-420 |
| 10 | Dow PP 3155 >.4 mils | 2 | 460 |
| 11 | Dow PP 4772 | 2 | 420 |
| 12 | Dow PP 5341E | 2 | 420 |
| 13 | Dow PP2252E1 | 2 | 420 |
| 14 | PE/PP/PE film | 1 | 320-350 |
| 15 | PE/PP/PE film | 0.5 | 320-350 |
| 16 | ExxonMobil VM 3000 ™ | 2 | 420 |
| 17 | ExxonMobil VM 3000 ™ | 2 | 420 |
| 18 | ExxonMobil VM 3000 ™ | 2 | 420 |

The samples listed in Table 2 used polymeric materials that were different than the polypropylene film used for the samples in Table 1. The formation pressure for all samples in Table 2 was 2500 psi. The porous material used for each sample in Table 1 was also used as the porous material for all samples in Table 2. The samples of Table 2 also showed good formation.

While many of the process parameters for the samples described in Tables 1 and 2 was varied, the most impactful process parameter was formation temperature. Specifically, it was noted that increasing the temperature within the range tested tended to decrease the density of the fibers in the grip enhancing material.

TABLE 3

| | | Heating | | Cooling |
|---|---|---|---|---|
| | | Time | Temp | time |
| Sample | Polymer Substrate | (min) | (F) | (min) |
| 1 | PE foam w/skin | 1.5 | 460 | 2 |
| 2 | Xray PP film w/ thin Penthouse | 2 | 460 | 2 |
| | foam on top | | | |
| 3 | Xray PP film w/ Caligen foam on | 2 | 460 | 2 |
| | top | | | |
| 4 | PE film underlay foam dark blue | 2 | 250 | 3 |
| 5 | PE film underlay foam dark blue | 4 | 250 | 3 |
| 6 | PE film underlay foam light blue | 2 | 250 | 3 |
| 7 | PE film underlay foam light blue | 1 | 250 | 3 |
| 8 | Styrenic block copolymer foam | 2 | 320- | 1 |
| | | | 380 | |
| 9 | Styrenic block copolymer foam | 1 | 320- | 1 |
| | | | 380 | |

The samples delineated in Table 3 each utilized a porous material having at least one foam side, with the foam side of the material being positioned adjacent to the porous material. The materials produced by the samples in Table 3 were less satisfactory than the samples produced in Tables 1 and 2 in that formation of bristles was not as consistent. All samples in Table 3 utilized a formation pressure of 2500 psi, and the same porous material that was used in the samples of Tables 1 and 2 was utilized for all samples in Table 3.

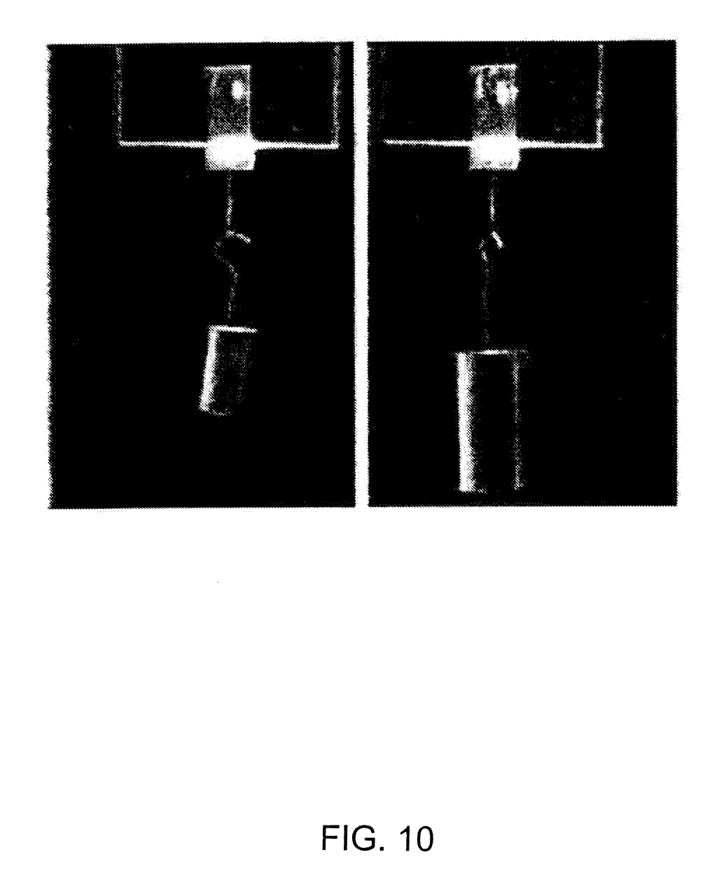

Some of the samples produced in accordance with the present invention were positioned on a glass surface as shown in FIG. 10 simply by pressing the bristles of the material onto the glass surface. A weight between 10 grams and 3 kilograms was attached to an end of each of the samples which was not adhered to the glass surface. The samples maintained their grip on the glass and supported the weights as shown in FIG. 10.

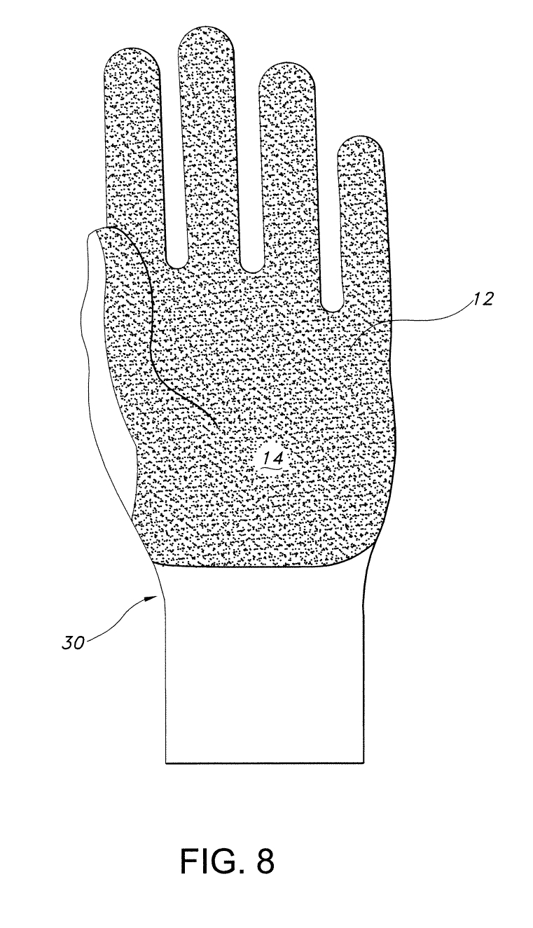

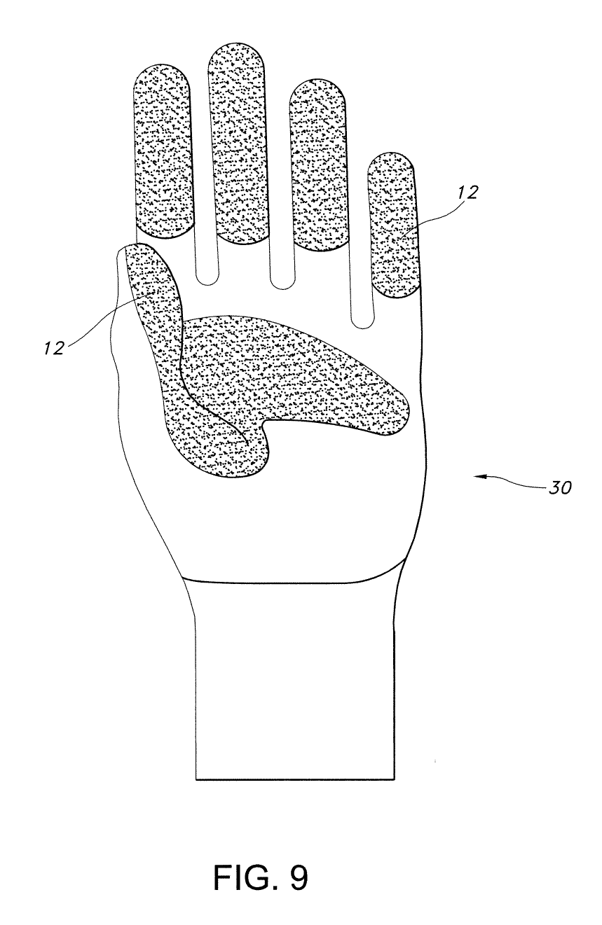

The grip enhancing material 12 may be placed on a glove 30, such as depicted in FIGS. 8 and 9, to enhance the ability of the glove to grip objects having many different types of surfaces. There are many ways in which a grip enhancing material may be positioned on a glove, and such positioning will depend in part on the intended use of the glove. The grip enhancing material may be formed directly on the glove, or may be separately formed and subsequently attached to the glove by any of several well-known methods such as adhesive, sonic lamination and the like.

As seen in FIG. 8, the material 12 may be positioned on the glove 30 to cover substantially the entire interior surface of the glove. In FIG. 9, the material 12 is applied selectively to portions of the glove such as the fingers and palm to increase glove performance. In some embodiments, the material 12 may cover the entire outer surface of the glove.

The grip enhancing material may also be placed on other articles which pick up and move objects, such as, for example, manufacturing equipment which picks and sorts small or smooth objects, mechanical grabbers used by those with limited mobility to pick up articles that would be out of their normal reach, and the like. The grip enhancing material may also be positioned directly on the object to be gripped.

It will be appreciated that the foregoing examples, given for purposes of illustration, are not to be construed as limiting the scope of this invention. Although only a few exemplary embodiments have been described in detail above, those skilled in the art will readily appreciate that many modifications are possible in the exemplary embodiments without materially departing from the novel teachings and advantages of this disclosure. Accordingly, all such modifications are intended to be included within the scope of this disclosure which is defined in the following claims and all equivalents thereto. Further, it is recognized that many embodiments may be conceived that do not achieve all of the advantages of some embodiments, yet the absence of a particular advantage shall not be construed to necessarily mean that such an embodiment is outside the scope of the present disclosure.

What is claimed is:

1. A grip enhancing material comprising:
a polymeric sheet having a first surface and a second surface; and
a plurality of elongated flexible bristles contiguous with the first surface, the elongated flexible bristles having
a root proximate to the first surface,
a tip spaced apart from the first surface,
a substantially continuous cross-sectional shape from the root to the tip of each bristle,
wherein at least a portion of the flexible bristles have an average aspect ratio of at least about 1:5, and wherein at least a portion of the flexible bristles have an average length of less than about 15 microns.

2. The grip enhancing material of claim 1 wherein at least a portion of the flexible bristles have an average aspect ratio less than about 1:30.

3. The grip enhancing material of claim 1 wherein the polymeric sheet includes polypropylene.

4. The grip enhancing material of claim 1 wherein the polymeric sheet includes polyethylene.

5. The grip enhancing material of claim 1 wherein there are at least about 10 million bristles per square centimeter.

6. The grip enhancing material of claim 1 wherein there are at least about 20 million bristles per square centimeter.

7. The grip enhancing material of claim 1 wherein the bristles are spaced apart from each other by at least about 1 micron.

8. A grip enhancing glove comprising:
a grip enhancing material including a polymeric sheet having a first surface and a second surface, and a plurality of elongated flexible bristles contiguous with the first surface, the elongated flexible bristles having a root proximate to the first surface, a tip spaced apart from the first surface, and a substantially continuous cross-sectional shape from the root to the tip of each bristle, wherein at least a portion of the flexible bristles have an average aspect ratio of at least about 1:5, and wherein at least a portion of the flexible bristles have an average length of less than about 15 microns; and
a glove comprising an outer surface having a palm region and a plurality of finger regions, wherein the grip enhancing material is positioned on a portion of the outer surface of the glove.

9. The glove of claim 8, wherein the grip enhancing material is positioned on at least one of the finger regions of the glove.

10. The glove of claim 8, wherein the grip enhancing material is positioned on at least a portion of the palm region of the glove.

11. The glove of claim 8 wherein the polymeric sheet includes polypropylene.

12. The glove of claim 8 wherein the polymeric sheet includes polyethylene.

13. The glove of claim 8 wherein there are at least about 20 million bristles per square centimeter.

14. The grip enhancing material of claim 1 wherein the bristles are spaced apart from each other by at least about 1 micron.

15. A method for forming a grip enhancing material comprising:
providing a porous material having a plurality of pores having an average width of less than about 2 microns which extend into the porous material for at least about 10 microns;
positioning a polymeric sheet adjacent to the porous material;
applying a combination of pressure and temperature to the porous material and polymeric sheet sufficient to cause at least a portion of the polymeric sheet to flow into at least a portion of the pores in the porous material; and
dissolving the porous material so that the polymeric sheet is separated from the porous material.

16. The method of claim 15 wherein the polymeric sheet includes polypropylene.

17. The method of claim 15 wherein the polymeric sheet includes polyethylene.

18. The method of claim 15 wherein the step of dissolving the porous material further includes the step of immersing the porous material and polymeric sheet in a solvent.

19. The method of claim 15 wherein the solvent is methyl chloride.
